(19) United States
(12) Patent Application Publication
(10) Pub. No.: US 2017/0041621 A1
(43) Pub. Date: Feb. 9, 2017

(54) METHODS, DECODER AND ENCODER FOR MANAGING VIDEO SEQUENCES

(71) Applicant: Telefonaktiebolaget L M Ericsson (publ), Stockholm (SE)

(72) Inventors: Rickard SJÖBERG, Stockholm (SE); Ruoyang Yu, Solna (SE)

(21) Appl. No.: 15/102,343

(22) PCT Filed: Dec. 18, 2013
(86) PCT No.: PCT/EP2013/077201

§ 371 Date: Jun. 7, 2016

(51) Int. Cl. H04N 19/174; H04N 19/196; H04N 19/42; H04N 19/436

(52) U.S. Cl. CPC H04N 19/174; H04N 19/436; H04N 19/196; H04N 19/42

(57) ABSTRACT

Methods, decoders, and encoders are disclosed for managing a video sequence while using at least a number of processing cores. The video sequence represents a picture. The picture comprises a number of partitions, which are independent from each other with respect to decoding of the picture. The decoder or the encoder estimates a set of values, wherein each value of the set corresponds to a corresponding partition of the number of partitions, and wherein each value relates to decoding time of its corresponding partition. The decoder decodes or the encoder encodes the number of partitions based on the decoding time as given by the set of values, while using the number of processing cores, at least initially, in parallel. Moreover, corresponding computer programs and computer program products are disclosed.

### TECHNICAL FIELD

Embodiments herein relate to video coding. In particular, a method and a decoder for managing a coded video sequence while using multiple processing cores as well as a method and an encoder for managing a video sequence while using multiple processing cores are disclosed. Moreover, corresponding computer programs and computer program products are disclosed.

### BACKGROUND

With video coding technologies, it is often desired to compress a video sequence. The video sequence may for example have been captured by a video camera. A purpose of compressing the video sequence is to reduce a size, e.g. in bits, of the video sequence. In this manner, the coded video sequence will require less space, when stored on e.g. a memory of the video camera and/or less bandwidth when transmitted from e.g. the video camera, than the video sequence, i.e. the uncompressed video sequence. A so called encoder is often used to perform compression, or encoding, of the video sequence. Hence, the video camera may comprise the encoder. The coded video sequence may be transmitted from the video camera to a display device, such as a television set (TV) or the like. In order for the TV to be able to decompress, or decode, the coded video sequence, it may comprise a so called decoder. This means that the decoder is used to decode the received coded video sequence, e.g. decompress or unpack pictures of the coded video sequence such that they may be displayed at the TV. Generally, the decoder and/or encoder may be included in various platforms, such as television set-top-boxes, television headends, video players/recorders, such as video cameras, Blu-ray players, Digital Versatile Disc (DVD)-players, media centers, media players and the like.

According to some video coding formats, a picture, or a frame, is partitioned into blocks which are processed sequentially. A size of each block, referred to as block size e.g. in terms of pixels of the picture, may be different for different video coding formats. For instance, H.264 video coding format uses a block size of 16×16 pixels and High Efficiency Video Coding (HEVC) format generally uses a block size of 64×64 pixels.

A known decoder, or encoder, may include multiple processing cores. In order to take advantage of the multiple processing cores, many video formats allow for partitioning or splitting of pictures into individually processable partitions. A partition includes one or more blocks, which may e.g. be 64×64 pixels as mentioned above. Since the individually processable partitions are independent of each other with respect to processing thereof, it is possible to process multiple partitions in parallel, i.e. at the same time, while using the multiple processing cores. This is often referred to as parallel processing of e.g. partitions.

Two examples of partitions that are used for supporting parallel processing are slices and tiles.

Slices have been used in many video coding formats, such as H.261, Moving Picture Experts Group (MPEG)-2, MPEG-4, H.264, and HEVC. A slice consists of a sequence of blocks in raster scan order which can be decoded independently of other slices. In the H.264 and HEVC video formats, a Network Abstraction Layer (NAL) unit represents a slice. The NAL units define a format in which video data is stored and transported. Therefore, according to the H.264 video format, each slice is one NAL unit and each NAL unit is one slice. FIG. 1 is an illustration of where multiple threads ‘Thread 1’ to ‘Thread 4’ are used for decoding of different slices, enclosed by bold lines. Blocks are shown within dashed lines.

Accordingly, in this context, a number of threads can be used. This implies that the actual workload of the encoding/decoding process can be divided into separate “processes” that are performed independently of each other. Typically, the processes are executed in parallel in separate threads.

In the HEVC format, tiles are also supported, where each tile is either split into an integer number of slices or a slice comprises an integer number of tiles. The tiles define horizontal and vertical boundaries that partition a picture into columns and rows. Tiles do not have a one-to-one relationship with NAL units. The starting point of each tile's data inside a bitstream is signaled by a so called entry point offset in a slice header.

The entry point offset indicates the offset, in bytes, from the end of a slice header to the beginning of a tile in the slice. A decoder with multiple processing cores can use the entry point offset to find different titles. Then, the decoder can process the different titles in parallel on multiple processing cores.

One common way of using tiles is to put all tiles of a picture into one slice. For the most common transport formats such as Internet Protocol (IP), each slice becomes one IP packet. This means that slices will be delivered to the decoder one-by-one and that all tiles will be received at the same instance in time. For example, all six tiles, enclosed by bold lines, in FIG. 2 will be made available for decoding at the same time. Therefore, multiple threads ‘Thread 1’ to ‘Thread 6’ are used for decoding of all six tiles. Similarly to as for FIG. 1, blocks are shown within dashed lines.

Independent partitions of a picture give a video processor a possibility to realize parallel processing. However, in most scenarios, the complexity between different partitions typically varies, which result in unbalanced load between different processing cores of e.g. a decoder. For example, certain partitions may contain a lot of motion or details, while others contain only static background. When a current partition of a picture contains a lot of motion this may be understood as that pixels in the current partition for the picture have changed a lot in comparison to pixels in the current partition for a previous picture. The pixels may have changed because e.g. an object has been moved in the current partition of the first picture as compared to where the object was placed in the current partition for the previous picture. Partitions with a lot of motion are typically more complex to process than partitions with only background. This is applies to both encoding and decoding.

For different platforms, as exemplified above, the number of processing cores may vary. It may be the case that the picture to be processed is partitioned into a greater number of partitions than the number of processing cores of the platform.

In FIG. 3, a picture with three partitions, ‘Partition 1’ to ‘Partition 3’, is shown as an example. ‘Partition 1’ and ‘partition 2’ each take 25 ms for one core to process. ‘Partition 3’ takes 50 ms. A total processing time for a single core to process the three partitions would thus be (25+25+50) ms=100 ms.

Now assume that two cores are used for processing of the picture. According to known methods, the partitions of the picture are processed in so called raster scan order. This means that ‘partition 1’ and ‘partition 2’ will be processed first while using the two cores in parallel. Thus, processing of both ‘partition 1’ and ‘partition 2’ takes 25 ms. Then, one of the cores will process ‘partition 3’. Processing of ‘partition 3’ takes 50 ms. A total time to process the picture will thus be (25+50) ms=75 ms.

For many applications, it is desired that the processing time is as short as possible. Thus, a disadvantage with the known method is that it takes too long time to process the picture even though there are multiple cores.

### SUMMARY

An object is to improve video processing while using multiple processing cores.

According to a first aspect, the object is achieved by a method, performed by a decoder comprising multiple processing cores enabling parallel decoding, for managing a coded video sequence while using at least a number of processing cores of the decoder. The coded video sequence represents a picture. The picture comprises a number of partitions, which are independent from each other with respect to decoding of the picture. The number of processing cores is less than the number of partitions, and the number of processing cores is greater than one. The decoder estimates a set of values, wherein each value of the set corresponds to a corresponding partition of the number of partitions, wherein each value relates to decoding time of its corresponding partition. The decoder decodes the number of partitions based on the decoding time as given by the set of values. The decoding is performed by using the number of processing cores, at least initially, in parallel.

According to a second aspect, the object is achieved by a decoder comprising multiple processing cores enabling parallel decoding, configured to manage a coded video sequence while using at least a number of processing cores of the decoder. The coded video sequence represents a picture. The picture comprises a number of partitions, which are independent from each other with respect to decoding of the picture. The number of processing cores is less than the number of partitions, and the number of processing cores is greater than one. The decoder is configured to estimate a set of values, wherein each value of the set corresponds to a corresponding partition of the number of partitions, wherein each value relates to decoding time of its corresponding partition. The decoder is configured to decode the number of partitions based on the decoding time as given by the set of values. The decoder is configured to decode the number of partitions by use of the number of processing cores, at least initially, in parallel.

According to a third aspect, the object is achieved by a method, performed by an encoder comprising multiple processing cores enabling parallel encoding, for managing a video sequence while using at least a number of processing cores of the encoder. The video sequence represents a picture and the picture comprises a number of partitions, which are independent from each other with respect to decoding of the picture. The number of processing cores is less than the number of partitions, and the number of processing cores is greater than one. The encoder estimate a set of values, wherein each value of the set corresponds to a corresponding partition of the number of partitions, wherein each value relates to encoding time of its corresponding partition. The encoder encodes the number of partitions based on the encoding time as given by the set of values. The encoding is performed by using the number of processing cores, at least initially, in parallel.

According to a fourth aspect, the object is achieved by an encoder, comprising multiple processing cores enabling parallel encoding, configured to manage a video sequence while using at least a number of processing cores of the encoder. The video sequence represents a picture and the picture comprises a number of partitions, which are independent from each other with respect to decoding of the picture. The number of processing cores is less than the number of partitions, and the number of processing cores is greater than one. The encoder is configured to estimate a set of values, wherein each value of the set corresponds to a corresponding partition of the number of partitions, wherein each value relates to encoding time of its corresponding partition. The encoder is configured to encode the number of partitions based on the encoding time as given by the set of values. The encoder is configured to encode the number of partitions by use of the number of processing cores, at least initially, in parallel.

According to a fifth aspect, the object is achieved by a computer program for managing a coded video sequence. The computer program comprises computer readable code units which when executed by a decoder causes the decoder to perform the method in the decoder described herein.

According to a sixth aspect, the object is achieved by a computer program product, comprising a computer readable medium and a computer program as described herein stored on the computer readable medium.

According to a seventh aspect, the object is achieved by a computer program for managing a video sequence. The computer program comprises computer readable code units which when executed by a encoder causes the encoder to perform the method in the encoder described herein.

According to an eighth aspect, the object is achieved by a computer program product, comprising a computer readable medium and a computer program as described herein stored on the computer readable medium.

Due to that time for processing of different partitions is estimated, it is possible to process, e.g. decode and/or encode, certain partitions in certain processing cores based on time for processing, e.g. decoding time and/or encoding time. In this manner, time for processing of the picture may be distributed more evenly among the used processing cores. This means in turn that time in which processing is performed in parallel is increased. Therefore, a total time for processing of the picture will be reduced. As a result, the above mentioned object is achieved.

According to embodiments herein, a load balancing scheme to improve the parallel performance of the decoder or the encoder as mentioned above is described. The load balancing scheme balances load, e.g. in terms of processing time as mentioned above, between the used processing cores. This may mean that processing time may be distributed among the processing cores in an efficient manner.

An advantage with the embodiments herein is that the number of processing cores of the encoder or the decoder are efficiently used, e.g. in terms of reducing idle time of the number of processing cores. “Idle time” has its conventional meaning in the field of computer processor, i.e. the idle time relates to time when a processor does not perform any action as e.g. instructed by a program or hardware.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 is a block illustration of partitions of a picture and threads that process each partition of the picture,

FIG. 2 is another block illustration of partitions of a picture and threads that process each partition of the picture,

FIG. 3 is a further block illustration of partitions and their respective times for processing thereof,

FIG. 4 is an overview of an exemplifying system in which embodiments herein may be implemented,

FIG. 5 is a schematic, combined signaling scheme and flowchart illustrating embodiments of the methods when performed in the system according to FIG. 4,

FIG. 6 is a flowchart illustrating embodiments of an exemplifying method in a device, including the decoder and/or the encoder,

FIG. 7 is a flowchart illustrating embodiments of another exemplifying method in a further device, including the decoder and/or the encoder,

FIG. 8 is a flowchart illustrating embodiments of the method in the encoder,

FIG. 9 is a flowchart illustrating other embodiments of the method in the encoder,

FIG. 10 is a flowchart illustrating embodiments of the method in the decoder,

FIG. 11 is an overview of partitions in pictures, bitstreams and handling for processing,

FIG. 12 is a flowchart illustrating other embodiments of the method in the decoder,

FIG. 13 is a block illustration of partitions in a current picture and a previous picture,

FIG. 14 is a block diagram illustrating embodiments of the decoder, and

FIG. 15 is a block diagram illustrating embodiments of the encoder.

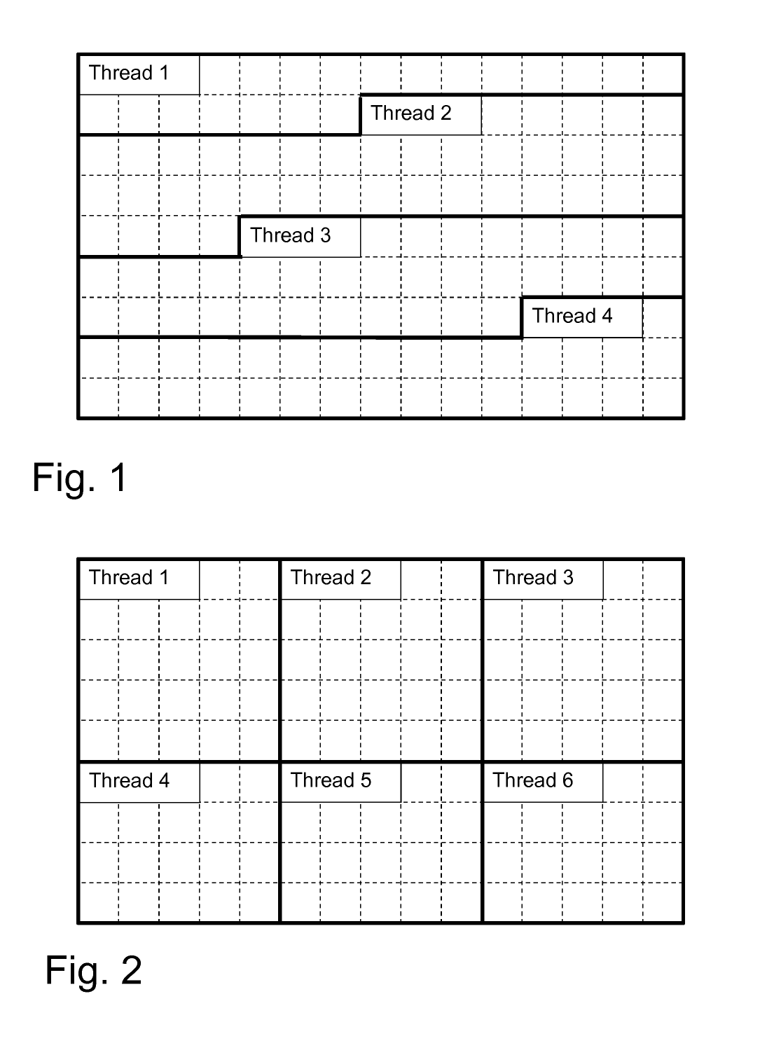

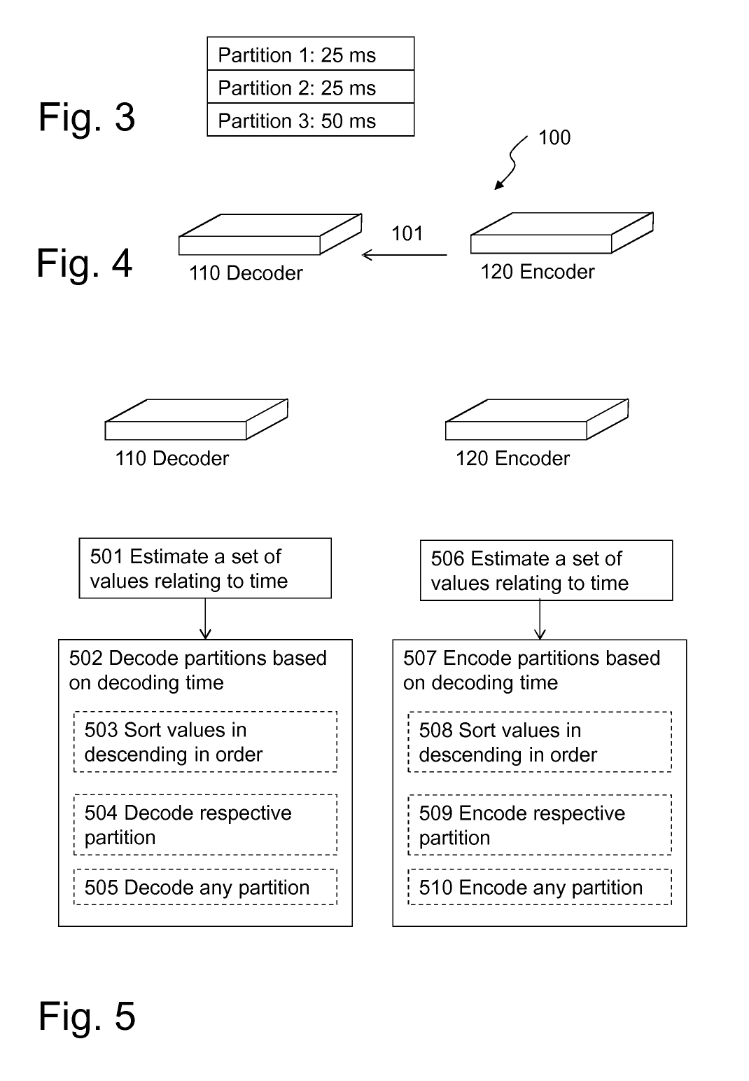

### DETAILED DESCRIPTION

Throughout the following description similar reference numerals have been used to denote similar elements, units, modules, circuits, nodes, parts, items or features, when applicable. In the Figures, features that appear in some embodiments are indicated by dashed lines unless otherwise noted.

FIG. 4 depicts an exemplifying system 100 in which embodiments herein may be implemented. In this example, the system 100 comprises a decoder 110 and an encoder 120.

The decoder 110 and/or the encoder 120 may be comprised in various platforms, such as television set-top-boxes, video players/recorders, video cameras, Blu-ray players, Digital Versatile Disc (DVD)-players, media centers, media players, user equipments and the like. As used herein, the term “user equipment” may refer to a mobile phone, a cellular phone, a Personal Digital Assistant (PDA) equipped with radio communication capabilities, a smartphone, a laptop or personal computer (PC) equipped with an internal or external mobile broadband modem, a tablet PC with radio communication capabilities, a portable electronic radio communication device, a sensor device equipped with radio communication capabilities or the like. The sensor may be a microphone, a loudspeaker, a camera sensor etc.

As an example, the encoder 120 may send 101 a bitstream to the decoder 110. The bitstream may be video data, e.g. in the form of one or more NAL units. The video data may thus for example represent pictures of a video sequence.

FIG. 5 illustrates an exemplifying method for managing video sequences, e.g. coded video sequences as well as non-coded video sequences when implemented in the decoder 110 and encoder 120, respectively.

The following actions, or steps, may be performed in any suitable order. The actions in the decoder 110 are described first for simplicity.

Initially, the decoder 110 may receive at least one NAL unit of a bitstream including a coded video sequence.

In this example, the decoder 110 comprises multiple processing cores enabling parallel decoding.

Thus, decoder 110 performs a method for managing a coded video sequence while using at least a number of processing cores of the decoder 110. In more detail, the decoder 110 may perform a method for processing, i.e. decoding, one or more pictures of the video sequence, i.e. a coded video sequence. The number of processing cores of the decoder 110 may be some of the multiple processing cores or the multiple processing cores.

The coded video sequence represents a picture, i.e. at least one picture. Therefore, the coded video sequence may be said to comprise the picture. The picture comprises a number of partitions, which are independent from each other with respect to decoding of the picture. The number of processing cores is less than the number of partitions, and the number of processing cores is greater than one.

The partitions may be slices or the partitions may be tiles, which have been described in the background section.

### Action 501

In order to be able to use a set of values in action 502, the decoder 110 estimates the set of values.

Each value of the set corresponds to a corresponding partition of the number of partitions. Moreover, each value relates to decoding time of its corresponding partition. Herein decoding time refers to an estimated decoding time corresponding to a respective value unless otherwise noted, or implicitly given by context. Expressed somewhat differently, a respective value of the set corresponds to a respective partition of the number of partitions. As an example, a picture may comprise four partitions. Then, there will be four estimated values relating to decoding time, i.e. one estimated value for each of the four partitions.

The time may be given in seconds, clock cycles or the like. It shall be noted that it's relative decoding times for the different partitions that may be of interest in some embodiments.

The estimation of the set of values may be performed according to the examples in section “Estimating time for processing” below.

### Action 502

The decoder 110 decodes the number of partitions based on the decoding time as given by the set of values. The decoding is performed by using the number of processing cores, at least initially, in parallel.

In this manner, the decoder 110 takes advantage of the information relating to decoding time such as to more evenly distribute tasks of decoding a respective partition. It may be that each task is executed in a separate thread, or there may be separate threads for each of the number of processing cores, where each thread may be given a plurality of tasks of decoding.

The decoding 502 of the number of partitions based on the decoding time as given by the set of values may be performed by decoding the number of partitions in descending order with respect to the decoding time, or processing time, as given by the set of values.

### Action 503

The decoder 110 may sort the number of partitions into a sorted list. The list may be sorted in descending order with respect to the decoding time as given by the set of values. Hence, those partitions that will take the longest time to decode will be put first in the list.

### Action 504

As an example, the number of processing cores may be N. Then, the decoder 110 may decode, in each of the number of processing cores, a respective one of the first N partitions of the sorted list. Hence, N partitions will be processed while using N processing core in parallel.

### Action 505

When any one of the N processing cores has finalized the decoding of the respective one of the first N partitions, the decoder 110 may decode, in said any one of the N processing cores, any partition that may be the first non-decoded partition according to the sorted list. This means that the decoder 110 will successively, and in descending order, begin decoding of partitions in the order indicated by the list.

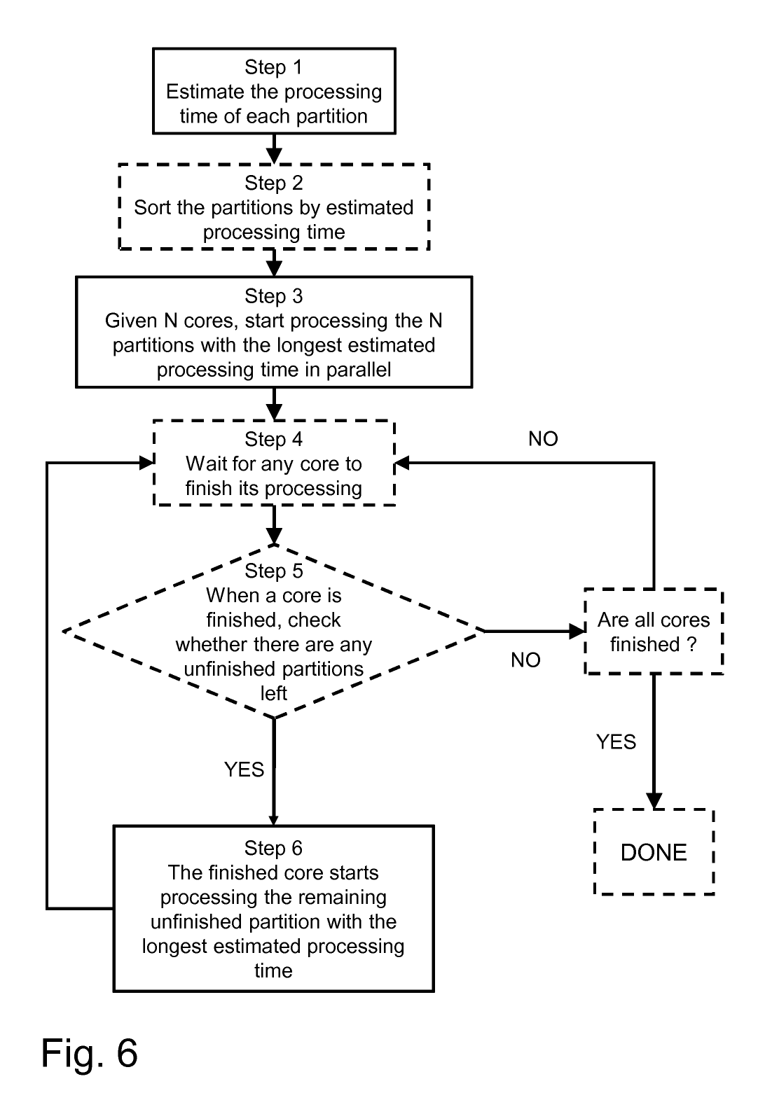

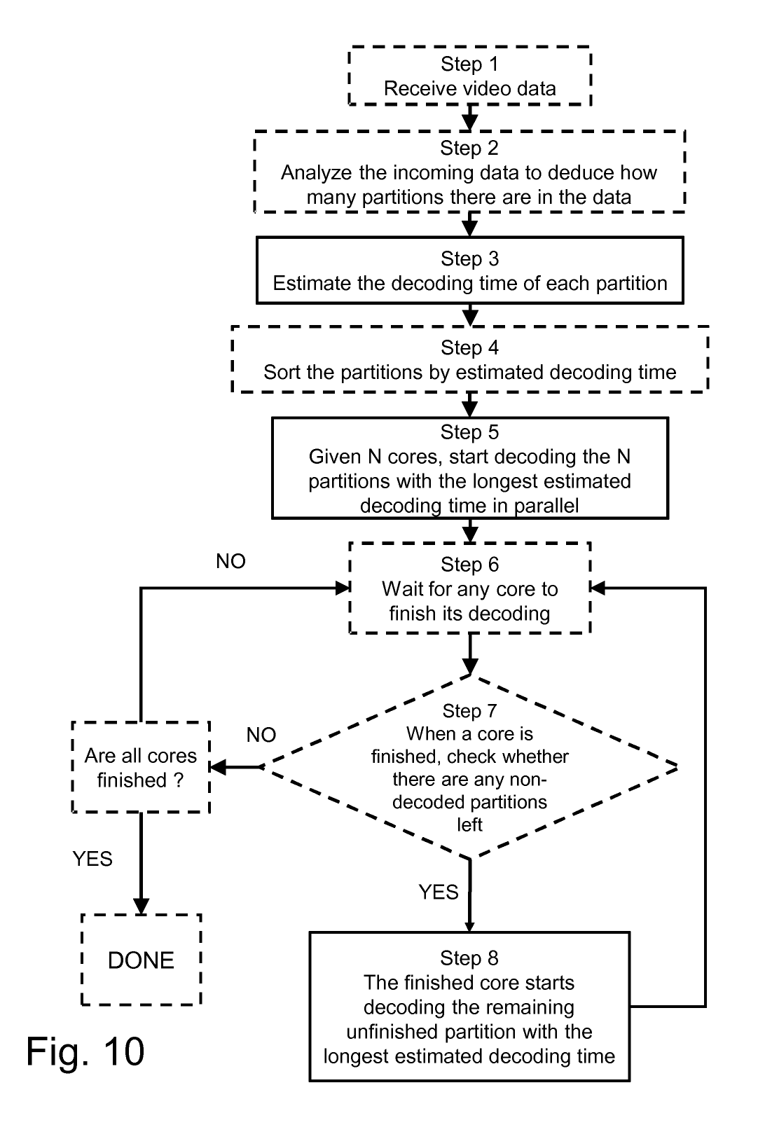

Actions 503-505 describe an embodiment referred to as embodiments with one queue, wherein queue may be an example of the list. Examples of the embodiments with one queue are shown in FIGS. 6 and 10 below.

Furthermore, FIG. 5 also illustrates a method, performed by the encoder 120, for managing a video sequence while using at least a number of processing cores of the encoder 120. In more detail, the encoder 120 may perform a method for processing, i.e. encoding, one or more pictures of the video sequence. The encoder 120 comprises multiple processing cores enabling parallel encoding. The number of processing cores of the encoder 120 may be some or all of the multiple processing cores.

The video sequence represents a picture, i.e. at least one picture. Thus, the video sequence may be said to comprise the picture. The picture comprises a number of partitions, which are independent from each other with respect to decoding of the picture. The number of processing cores is less than the number of partitions, and the number of processing cores is greater than one.

As mentioned, the partitions may be slices or the partitions may be tiles.

### Action 506

The encoder 120 estimates a set of values. Each value of the set corresponds to a corresponding partition of the number of partitions. Each value relates to encoding time of its corresponding partition.

The estimation of the set of values may be performed according to the examples in section “Estimating time for processing” below.

### Action 507

The encoder 120 encodes the number of partitions based on the encoding time as given by the set of values. The encoding is performed by using the number of processing cores, at least initially, in parallel.

The encoding of the number of partitions based on the encoding time as given by the set of values may be performed by encoding the number of partitions in descending order with respect to the encoding time as given by the set of values. The encoding time refers to estimated encoding time.

### Action 508

The encoder 120 may sort the number of partitions into a sorted list. The list may be sorted in descending order with respect to the encoding time as given by the set of values.

### Action 509

As an example, the number of processing cores may be N. The encoder 120 may encode, in each of the number of processing cores, a respective one of the first N partitions of the sorted list.

### Action 510

When any one of the N processing cores has finalized the encoding of the respective one of the first N partitions, the encoder 120 may encode, in said any one of the N processing cores, any partition that may be the first non-encoded partition according to the sorted list.

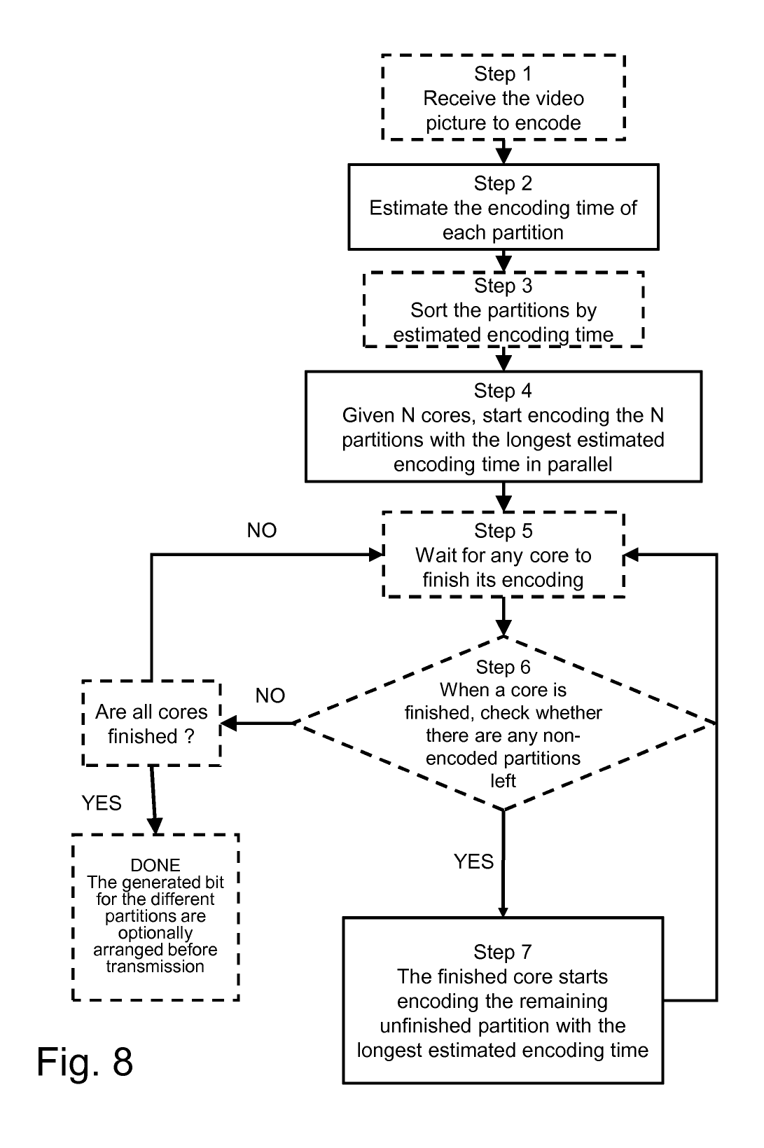

Actions 508-510 describe the embodiments with one queue with reference to the encoder 120. Examples of the embodiments with one queue are shown in FIGS. 6 and 8 below.

In the following some exemplifying embodiments are shown with reference to FIGS. 6-10 and 12. In these embodiments, it is assumed that a picture has been partitioned into the number of partitions. Moreover, it is assumed that the number of processing cores, e.g. N cores, is used as in the previous examples. As mentioned, the number of processing cores is less than the number of partitions.

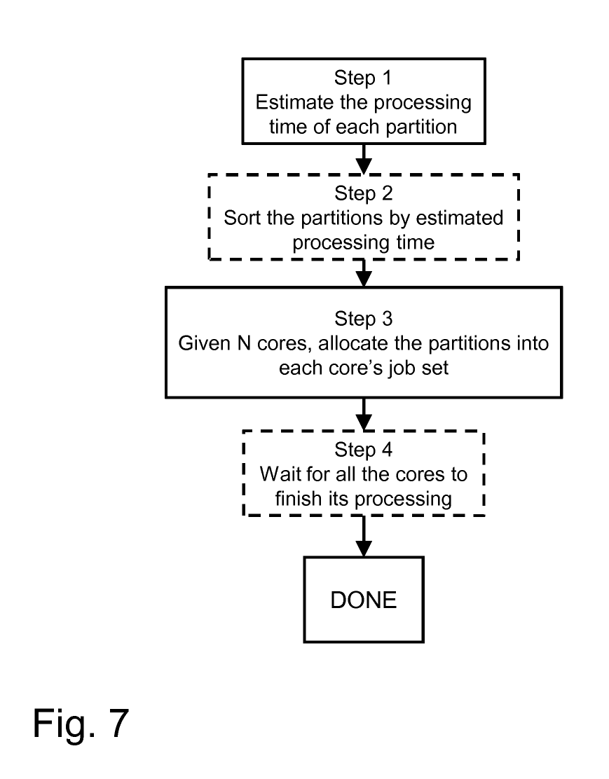

Now with reference to FIGS. 6 and 7, embodiments, including the methods performed by the decoder 110 and encoder 120 as illustrated in FIG. 5, are described. In these embodiments, a device (not shown), e.g. any of the above mentioned platforms, may include the decoder 110 and/or the encoder 120. This means that FIG. 6 is a generalization of FIG. 5 when the actions of the decoder 110 and encoder 120 are merged by using wording like “processing” for “decoding”/“encoding” and “processing time” for “decoding time”/“encoding time”. The decoder 110 and encoder 120 may referred to as a video coder, included in the device.

Hence, in this purely illustrative example with reference to FIG. 6, the following steps, or actions, may be performed in any suitable order.

Step 1

The device estimates the respective value, e.g. in the form of individual processing time for each partition. This step is similar to action 501 and 506.

Step 2

The device may sort the partitions by their estimated processing time. This step is similar to action 503 and 508.

Step 3

The device may put the partitions in one common job queue, or one queue for short, that is shared among the cores. The processing of the N partitions with the longest estimated processing time is immediately started in parallel in each core. The term “job” may refer to processing, such as decoding or encoding, of one partition. This step is also similar to action 503 and 508.

Step 4

The device may check if any core is finished with its processing of a partition. Expressed differently, the device may wait until any core is finished with its processing.

Step 5

Then, e.g. after step 4, the device may check if there are any unfinished, or unprocessed, partitions in the common job queue.

Step 6

The device starts to process the remaining unprocessed partition(s) with the longest estimated processing time in the core that was found to be finished in step 4. This step is repeated until all partitions of the picture have been processed.

Steps 4, 5 and 6 are similar to action 505 and 510.

As an alternative to the method of FIG. 6, FIG. 7 shows a flowchart illustrating an exemplifying embodiment performed by the device where each core has its own job queue. In this embodiments, absolute estimated decoding times may be of interest. Action 501, 502 and action 506 and 507 be may elaborated as described below.

The following steps may be performed in any suitable order.

Step 1 and 2 are the same as illustrated above.

Step 3

The device allocates the partitions, or rather indicators to the partitions, into each core's job set, e.g. there may be one list for each processing core. There will thus be one job set for each of the N cores. As an example, a job set is a queue dedicated to one particular core. This means that the number of job sets equals to the number of cores.

The device may allocate the partitions into the job sets by the following steps:
The N partitions with the longest estimated processing time are allocated to each job set individually. As an example, if there are three cores and thus three job sets, the first partition in each respective job set will be one of the three partitions with the longest estimated processing time.
The next unallocated partition is allocated to the job set with the smallest summed estimated processing time. The summed estimated processing time includes the processing time of those partitions that already have been allocated to that particular job set. This step continues until there are no more partitions left unallocated.

The device starts to process the partitions in each job set in a respective core. It shall here be noted that the best result is achieved when a respective total length in time of each list is the same for all lists. In practical examples, the respective total length may be within a range to allow for some variation in the respective lengths. Notably, once the lists have been created, the order in which the partitions may be processed, in each processing core, may be arbitrary. However, the processing order, in each processing core, may as mentioned above be in descending order with respect to the estimated processing time.

Step 4

The device may check if all N cores have processed all partitions in its respective job set. In this manner, the device may wait for all the cores to finish its processing.

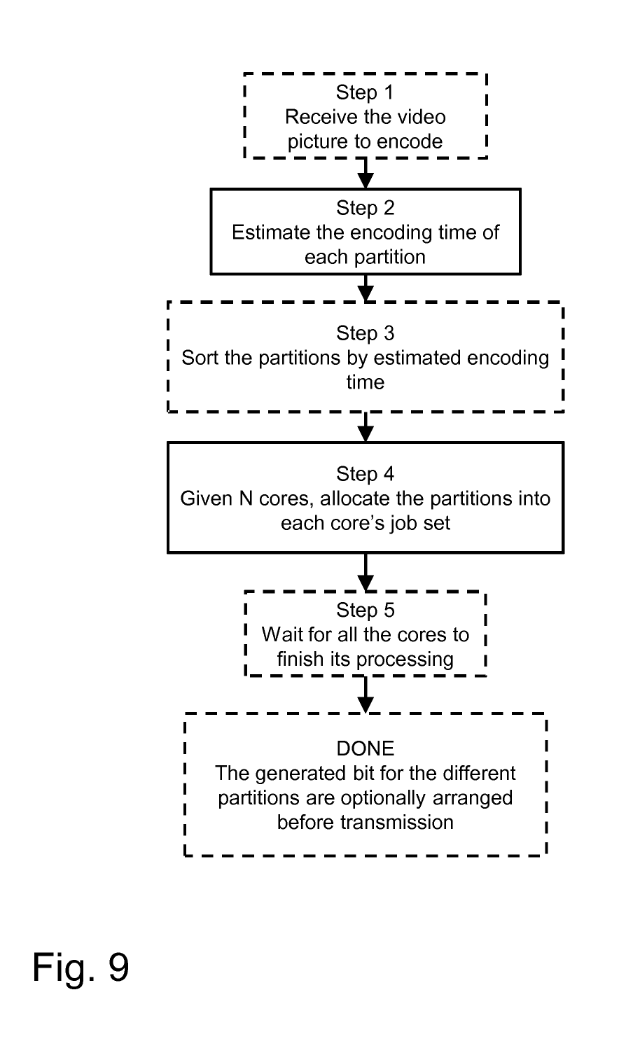

Turning to FIGS. 8 and 9, the methods illustrated with reference to FIG. 5 for the encoder and FIGS. 6 and 7 when performed by the encoder 120 are now described in an exemplifying manner.

With reference to FIG. 8, the following steps may be performed in any suitable order. This method is similar to the method of FIG. 6.

Step 1

The encoder 120 may receive a picture to encode. The picture may be comprised in a video sequence comprising e.g. uncompressed or non-encoded video data. Expressed colloquially, the video sequence may comprise raw video data.

Step 2

The encoder 120 estimates the encoding time of each partition. This step is similar to action 506.

Step 3 The encoder 120 may sort the partitions by the estimated encoding time e.g. in descending order. This step is similar to action 508.

Step 4

The encoder 120 may put the partitions, or rather indicators to the partitions, in a common job queue that is shared among the cores. As an example, if a picture comprises 4 partitions from left-top corner to right-lower corner, the indicators may be 1, 2, 3 and 4. The encoding of the N partitions with the longest estimated encoding time is started in parallel in each core. This step is also similar to action 508.

Step 5

The encoder 120 may check if any core is finished with its encoding of a partition. Expressed differently, the encoder 120 may wait until any core is finished with its encoding.

Step 6

Then, e.g. after step 5, the encoder 120 may check if there are any unfinished, or non-encoded, partitions in the common job queue.

Step 7

The encoder 120 starts to encode the remaining non-encoded partition(s) with the longest estimated encoding time in the core that was found to be finished in step 5. Steps 5, 6 and 7 are repeated until all partitions of the picture have been encoded.

Step 5, 6 and 7 are similar to action 509 and 510.

After all partitions have been encoded, there may be a re-arranging of the bits before the bits are e.g. sent to a receiver or stored. The bits from each partition may be put in raster scan order and bitstream pointers may be computed and stored in the case that tiles are used.

FIG. 9 shows another exemplifying block diagram in which the encoder performs the method illustrated in FIG. 7. This means that the processing of FIG. 7 will here in FIG. 9 be encoding.

The following steps may be performed in any suitable order.

Step 1, 2 and 3 of FIG. 9 are the same as steps 1, 2 and 3 in FIG. 8.

Step 4

The device allocates the partitions into each core's job set. There will thus be one job set for each of the N cores. As an example, a job set is a queue dedicated to one particular core. This means that the number of job sets equals to the number of cores.

The device may allocate the partitions into the job sets by the following steps:
The N partitions with the longest estimated encoding time are allocated to each job set individually. As an example, if there are three cores and thus three job sets, the first partition in each respective job set will be one of the three partitions with the longest estimated encoding time.
The next unallocated partition is allocated to the job set with the smallest summed estimated encoding time. The summed estimated encoding time includes the encoding time of those partitions that already have been allocated to that particular job set. This step continues until there are no more partitions left unallocated.

The device starts to encode the partitions in each job set in a respective core in parallel.

Step 5

The device may check if all N cores have encoded all partitions in its respective job set. In this manner, the device may wait for all the cores to finish its encoding.

As mentioned above, after all partitions have been encoded, there may be a re-arranging of the bits before the bits are e.g. sent to a receiver or stored. The bits from each partition may be put in raster scan order and bitstream pointers may be computed and stored in the case that tiles are used.

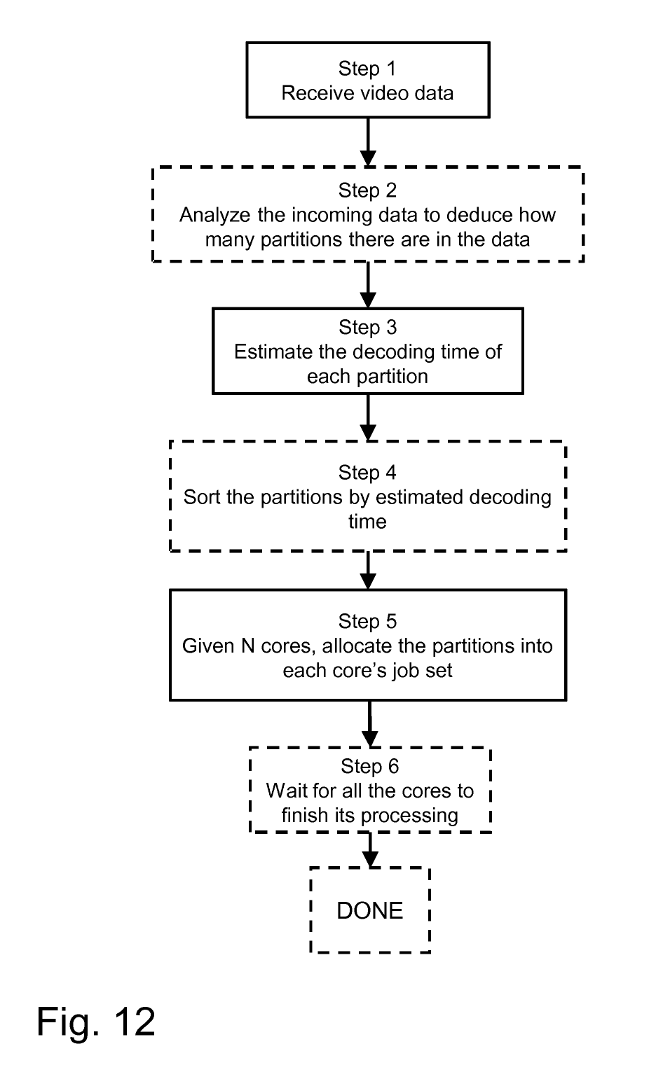

FIGS. 10 and 12 illustrate the methods illustrated with reference to FIG. 5 for the decoder 110 and FIGS. 6 and 7 when performed by the decoder 110.

With reference to FIG. 10, the following steps may be performed in any suitable order. This method is similar to the method of FIG. 6.

Step 1

The decoder 110 may receive a picture to decode. The picture may be comprised in video data, e.g. as part of a coded video sequence (CVS), e.g. known from HEVC.

Step 2

The decoder 110 may analyze the incoming video data to deduce the number of partitions.

Step 3

The decoder 110 estimates the decoding time of each partition. This step is similar to action 501.

Step 4

The decoder 110 may sort the partitions by the estimated decoding time e.g. in descending order. This step is similar to action 503.

Step 5

The decoder 110 may put the partitions in a common job queue that is shared among the cores. The decoding of the N partitions with the longest estimated decoding time is started in parallel in each core. This step is also similar to action 503.

Step 6

The decoder 110 may check if any core is finished with its processing of a partition. Expressed differently, the decoder 110 may wait until any core is finished with its decoding.

Step 7

Then, e.g. after step 6, the decoder 110 may check if there are any unfinished, or non-decoded, partitions in the common job queue.

Step 8

The decoder 110 starts to decode the remaining non-decoded partition(s) with the longest estimated decoding time using the core that was found to be finished in step 6. This step is repeated until all partitions of the picture have been decoded.

Steps 6, 7 and 8 are similar to action 504 and 505.

In one example of the embodiment of FIG. 10, video data for the entire picture arrives instantaneously. This may be the case in for example Real Time Transport Protocol (RTP) transmission of video where e.g. one slice per picture comprising multiple tiles are used.

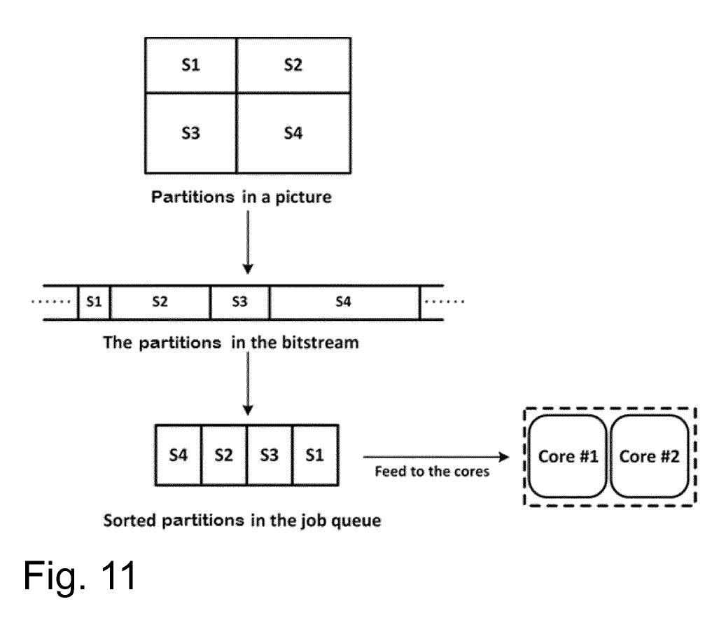

An example of partitions in a picture, in the bitstream and that partitions with greater respective values are processed first is shown in FIG. 11. A picture in a video sequence is encoded with four partitions: S1, S2, S3 and S4. The compressed data for each partition are then arranged in raster scan order and sent to a video decoder with two cores. Before any decoding operation takes place, the partitions are sorted in descending order with respect to estimated decoding time for each partition: S4, S2, S3 and S1. S4 and S2 are decoded in parallel first. For example, core #1 decodes S4 and core #2 decodes S2. As soon as one of the cores #1, #2 is finished, it decodes the remaining partition with the longest estimated decoding time, which is S3 in this case. If S4 is estimated to have a longer decoding time than S2, then core #2 will decode S3 if relations between the estimated decoding times and actual decoding times are the same. The partition S1 with the shortest estimated decoding time is decoded last. The one of the cores #1, #2 that finishes decoding of S4 and S3, respectively, will decode the partition S1.

FIG. 12 illustrates an exemplifying method performed by the decoder 110 similarly to the method described in FIG. 7 and/or FIG. 9 for the encoder 120.

Step 1, 2, 3 and 4 are the same in FIG. 10.

Step 5

The device allocates the partitions into each core's job set. There will thus be one job set for each of the N cores. As an example, a job set is a queue dedicated to one particular core. This means that the number of job sets equals to the number of cores.

The device may allocate the partitions into the job sets by the following steps:
The N partitions with the longest estimated decoding time are allocated to each job set individually. As an example, if there are three cores and thus three job sets, the first partition in each respective job set will be one of the three partitions with the longest estimated decoding time.
The next unallocated partition is allocated to the job set with the smallest summed estimated decoding time. The summed estimated decoding time includes the decoding time of those partitions that already have been allocated to that particular job set. This step continues until there are no more partitions left unallocated.

The device starts to decode the partitions in each job set in a respective core in parallel.

Step 6

The device may check if all N cores have decoded all partitions in its respective job set. In this manner, the device may wait for all the cores to finish its decoding.

### Estimating Time for Processing

In the following, estimation of the time for processing, as in e.g. action 501 and 506 above, will be described in more detail. The terms defined with reference to FIG. 5 will be reused here without repetition. The time for processing generally refers to the decoding time, the encoding time and/or the processing time. It deserves to be mentioned here that each value of the set of values may be represent a value, e.g. in ms, clock cycles, etc, corresponding to the estimated processing time. However, indirect ways of making the values related to the estimated processing time are also possible. For example, a value of the set may represent a range of processing times. However, still with sufficient resolution, i.e. sufficiently small ranges should correspond to a respective value, to make an efficient processing based on the times gives by the set of values.

Generally, for the decoder 110 and/or the encoder 120, the estimation of the set of values may be based on a respective size of the respective partition.

For the decoder 110, the respective size of the respective partition may relate to a respective size of the decoded respective partition in pixels, i.e. a so called spatial size.

As an example, the respective size of the respective partition may relate to a respective size of a portion of a bitstream, including, or rather representing, the respective partition, in bits, i.e. a bit size or bitstream size. The bit size does hence refer to a compressed, or encoded, size of the partition.

Hence, the estimated decoding time may be based on the bitstream size of partitions in e.g. a bitstream received at the decoder 110. It is assumed that the decoding time scales with size in bits of received partitions, sometimes referred to as partition bitstream size. This means that the partition with the largest coded size in bits, or bytes where 8 bits normally equals 1 byte, is expected to take the longest time to decode. Furthermore, the partition with the smallest size in bits is expected to take the shortest time to decode.

Additionally or alternatively, the estimated decoding time is based on the spatial size of partitions in e.g. a bitstream received at the decoder 110. It is assumed that the decoding time scales with spatial size in pixels of received partitions. This means that the partition with the largest spatial size is expected to take the longest time to decode. Furthermore, the partition with the smallest spatial size is expected to take the shortest time to decode.

As mentioned for the decoder 110 above, now also for the encoder 120, the estimation of the set of values may be based on a respective size of the respective partition.

The respective size of the respective partition may relate to a respective size of the encoded respective partition in pixels, e.g. a so called spatial size. Alternatively or additionally, the respective size of the respective partition may relate to a respective size of a portion of a bitstream, including the respective partition, in bits, e.g. a so called bit size or bitstream size.

In some embodiments, the estimation of the time for processing may be based on both spatial size and bit size. That is to say the estimated processing time, such as decoding time and/or encoding time, is a function of both size in compressed bits and size in pixels of the decoded partition. The function may be a linear weighting function or any other function.

In some embodiments, the estimation of the time for processing may utilize information relating to a previous picture.

Hence, for the decoder 110, the coded video sequence may comprise the previous picture, being previous in decoding order to the picture. The previous picture may alternatively be a closest picture in display order, or output order. The estimation of the set of values may be based on a respective decoding time of a respective previous partition in the previous picture. Display order, or sometimes output order, is an order which e.g. a TV displays pictures to a viewer. The display order is hence the order with respect to time of displaying, or outputting, the pictures.

Similarly for the encoder 120, the video sequence may comprise the previous picture, being previous in encoding order to the picture. The previous picture may alternatively be the closest picture in output order. The estimation of the set of values may be based on a respective encoding time of a respective previous partition in the previous picture.

As an example, for both the decoder 110 and the encoder 120, the estimation of the set of values may be based on a further respective size of a further respective partition relating to the previous picture, as mentioned above, in relation to the picture. The previous picture may be comprised in the uncompressed video sequence and/or the compressed coded video sequence.

In some examples, the information relating to the previous picture may be respective processing times for partitions of the previous picture. Hence, as an example for both the decoder 110 and the encoder 120, the estimation of the processing time may be that it is assumed that relations between processing times will be the same for consecutive pictures, i.e. the current picture and a previous picture.

This may apply if the partitions are kept constant between pictures, for example by using tiles of equal size.

In more detail, it is assumed that the relative processing time of a certain area is kept for consecutive pictures. This means that the partitions that have the corresponding longest previous processing time is expected to take the longest processing time for the current picture, and the partitions with the corresponding shortest previous processing time is expected to take the shortest processing time. The processing times of the partitions of the previous pictures here need to be stored between pictures.

If the partitions are not kept constant between pictures, the processing times for individual blocks can be saved from the previous picture. The processing times of the blocks that correspond to the partition of the current picture can be summed up and used as basis for the estimation.

In case a hierarchical B-picture structure or similar is used, the corresponding times of the closest previous and closest future picture can be summed together. Alternatively, one of them or the previous one in processing order can be used.

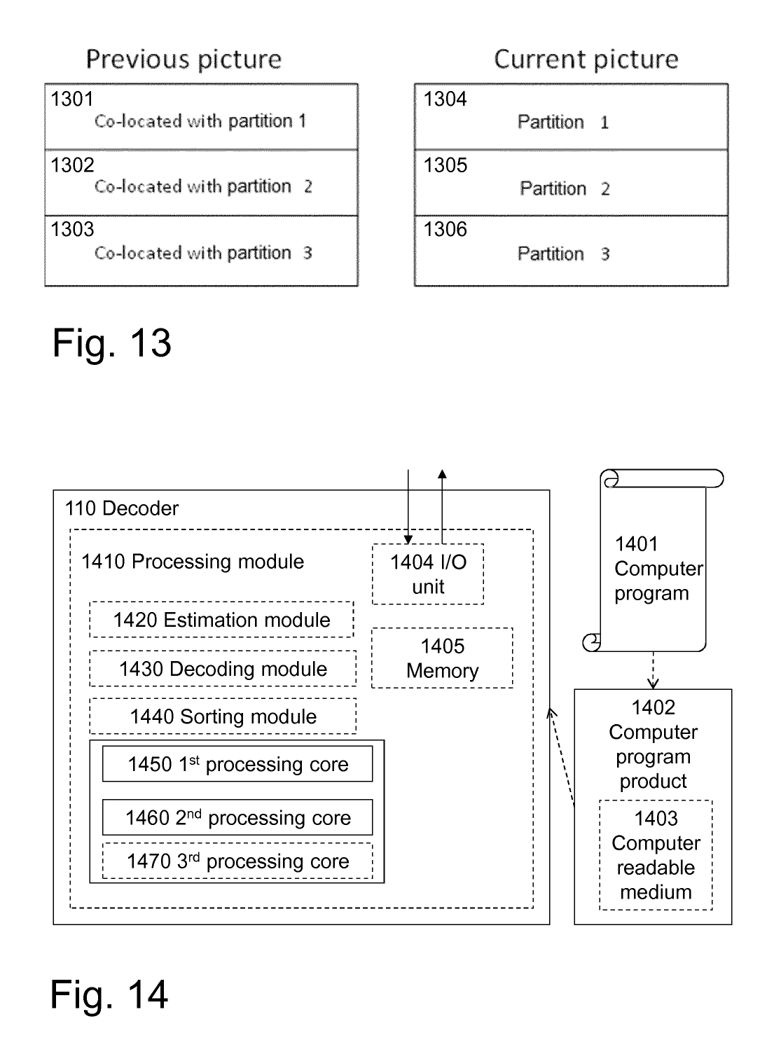

Referring to FIG. 13, co-located partitions 1301-1303 of a previous picture in relation to current partitions 1304-1306 of a current picture are illustrated. As can be seen from the FIG. 13, partitions 1301-1303 are referred to as being co-located with the current partitions 1304-1306 since the co-located partitions 1301-1303 have the same spatial positions as the corresponding current partitions 1304-1306.

Now that co-located partitions have been explained, the estimated processing time may be based on the bit size of the corresponding co-located partition of the previous picture. This applies to the encoder 120.

If the partitions are kept constant, i.e. same spatial size and location, for example by using constant tiles, the estimated processing time is done based on the bitstream size of the partitions from the previous picture.

It is assumed that the processing time scales with the bit size of the corresponding partition. This means that the partitions that has the largest corresponding coded size in bytes is expected to take the longest time to process, and the partitions with the smallest corresponding coded size in bytes is expected to take the shortest processing time. The bitstream size of the partitions of the previous pictures here needs to be stored between pictures.

If the partitions are not kept constant between pictures, the size in bits or bytes for individual blocks can be saved from the previous picture. The size of the blocks that corresponds to the partition of the current picture can be summed up and used as basis for the estimation.

In case a hierarchical B-picture structure or similar is used, the corresponding size of the closest previous and closest future picture can be summed together. Alternatively, one of them or the previous one in processing order can be used.

In some embodiments relating to the encoder 120, the video sequence may as mentioned comprise a previous picture, which is previous in encoding order to the picture. Sometimes, the encoding order may be referred to as the decoding order, since normally pictures may need to be encoded in the same order as those pictures are to be decoded.

The estimating of the set of values may comprise measuring, for each partition, a difference in pixel between the previous picture and the current picture.

In these embodiments, the estimated encoding time of each partition is done based on measuring their pixel difference from the previous picture.

It is assumed that the processing time for each partition scales with the difference between the current partition and its corresponding partition of a previous picture. The difference could be measured by SAD, SSE or other functions.

Sum of Absolute Difference (SAD): sum of the absolute value of pixel-wise difference between two blocks that have the same block size.

Sum of Square Error (SSE): sum of the square value of pixel-wise difference between two blocks that have the same block size.

The partition with largest difference is expected to have longest encoding time and that the partition with smallest difference is expected to have shortest encoding time.

One alternative of this embodiment is to measure the difference to a previous picture without any motion compensation. This means that the difference for each pixel is calculated with respect to the co-located pixel of a previous picture.

Another alternative is to measure the difference with motion compensation. In this case, the difference for each pixel is calculated relative to a motion compensated pixel value from a previous picture. Using motion compensated calculations are expected to be more useful in practice for encoders that perform motion estimation of the entire picture before actual encoding of the picture is done.

In an example of this embodiment without motion compensation and using SAD, the current picture consists of three partitions. The respective co-located areas from a previous picture are shown in the figure. Note that the previous picture does not need to have been processed using the same partition partitioning as the current picture. For each partition, the SAD of the partition is calculated. This is done by summing up the absolute value of the difference between each pixel in the partition and the corresponding co-located pixel from the previous picture.

$$SAD = {\sum }_{x , y} \vert {Curr}_{x , y} - {Prev}_{x , y} \vert$$

Curr_{x,y} is the pixel value of the pixel in the current picture with coordinate x,y. Prev_{x,y} is the pixel value of the pixel in the previous picture with coordinate x,y. The absolute difference is then summed over all the coordinates for each partition to form the SAD values. The estimation of the processing time is then based on these SAD values.

This estimation applies both to constant partitioning, as is common with tiles, and non-constant partitioning, as is normal with slices, between pictures.

The embodiments herein increase parallel efficiency of a video processor, such as the decoder 110 or the encoder 120 described herein. Parallel efficiency may be measured as a time period during which at least two processing cores of the video processor are busy with processing, such as decoding and/or encoding, of video data. Moreover, faster processing is achieved with the embodiments herein.

The embodiments with one queue have been implemented in a decoder, complying with HEVC and comprising at least two processing cores which may be operated in parallel, with performance improvements as compared to when partitions are processed in raster scan order. 10% decoding time speedup was achieved for decoding a bitstream using 3 partitions and 6.5% decoding time speedup was achieved for decoding a bitstream with 12 partitions. The test was done with 2 cores.

With reference to FIG. 14, a schematic block diagram of the decoder 110 is shown. The decoder 110 is configured to perform the methods in FIGS. 5, 6, 7, 10 and/or 12. The decoder 110, comprising multiple processing cores enabling parallel decoding, is configured to manage a coded video sequence while using at least a number of processing cores of the decoder 110.

As mentioned, the coded video sequence represents a picture. The picture comprises a number of partitions, which are independent from each other with respect to decoding of the picture. The number of processing cores is less than the number of partitions, and the number of processing cores is greater than one.

As mentioned, the partitions may be slices or the partitions may be tiles.

According to some embodiments herein, the decoder 110 may comprise a processing module 1410. In further embodiments, the processing module 1410 may comprise one or more of an estimating module 1420, a decoding module 1430, a sorting module 1440, which may be configured as described below.

The multiple processing cores may be exemplified by a first processing core 1450, a second processing core 1460, a third processing core 1470 and/or further processing cores.

The decoder 110, the processing module 1410 and/or the estimating module 1420 is configured to estimate a set of values, wherein each value of the set corresponds to a corresponding partition of the number of partitions, wherein each value relates to decoding time of its corresponding partition.

The decoder 110, the processing module 1410 and/or the decoding module 1430 is configured to decode the number of partitions based on the decoding time as given by the set of values. The decoder 110, the processing module 1410 and/or the decoding module 1430 is configured to decode the number of partitions by use of the number of processing cores, at least initially, in parallel.

The decoder 110, the processing module 1410 and/or the decoding module 1430 may be configured to decode the number of partitions based on the decoding time as given by the set of values by being configured to decode the number of partitions in descending order with respect to the decoding time as given by the set of values.

The decoder 110, the processing module 1410 and/or the estimating module 1420 may be configured to estimate the set of values based on a respective size of the respective partition.

The respective size of the respective partition may relate to a respective size of the decoded respective partition in pixels, or wherein the respective size of the respective partition may relate to a respective size of a portion of a bitstream, including the respective partition, in bits.

The coded video sequence may comprise a previous picture, being previous in decoding order to the picture. The decoder 110 may be configured to estimate the set of values based on a respective decoding time of a respective previous partition in the previous picture.

The decoder 110, the processing module 1410 and/or the sorting module 1440 may be configured to sort the number of partitions into a sorted list. The list may be sorted in descending order with respect to the decoding time as given by the set of values.

The number of processing cores may be N. The decoder 110 may be configured to decode, in each of the number of processing cores, a respective one of the first N partitions of the sorted list.

The decoder 110, the processing module 1410 and/or the decoding module 1430 may be configured to decode, in said any one of the N processing cores, any partition that may be the first non-decoded partition according to the sorted list, when any one of the N processing cores has finalized the decoding of the respective one of the first N partitions.

FIG. 14 also illustrates a computer program 1401 for managing a coded video sequence, wherein the computer program 1401 comprises computer readable code units which when executed on the decoder 110 causes the decoder 110 to perform the method in the decoder 110 as disclosed herein.

Finally, FIG. 14 shows a computer program product 1402, comprising a computer readable medium 1403 and the computer program 1401 as described directly above, stored on the computer readable medium 1403.

The decoder 110 may further comprise an Input/output (I/O) unit 1404 configured to send and/or receive the bitstream, any messages, values, indications and the like as described herein. The I/O unit 1404 may comprise a transmitter and/or a receiver or the like.

Furthermore, the decoder 110 may comprise a memory 1405 for storing software to be executed by, for example, the processing module when the processing module is implemented as a hardware module comprising at least two processing cores or the like.

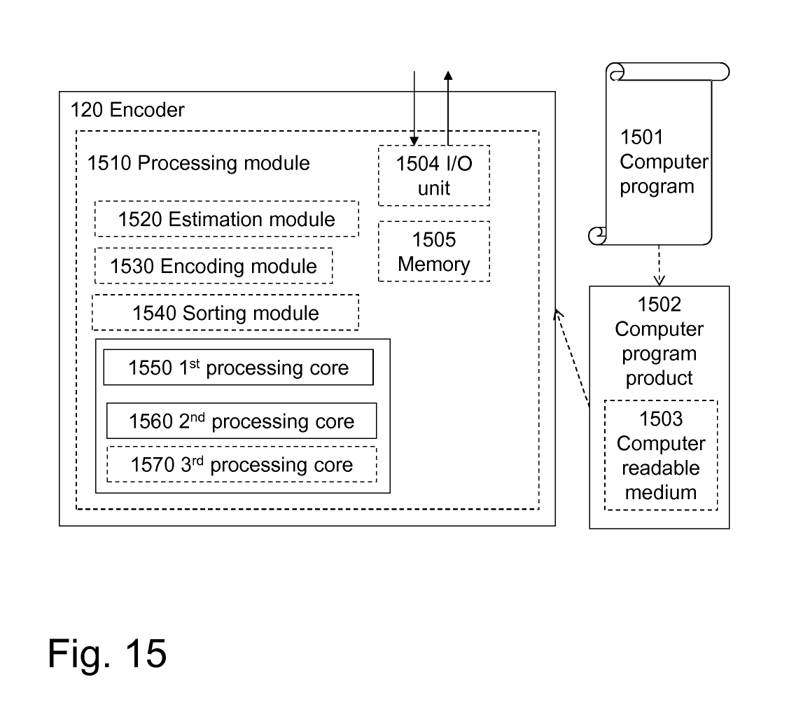

With reference to FIG. 15, a schematic block diagram of the encoder 120 is shown. The encoder 120 is configured to perform the methods in at least one of FIGS. 5-9. The encoder 120, comprising multiple processing cores enabling parallel encoding, is configured to manage a video sequence while using at least a number of processing cores of the encoder 120.

As mentioned, the video sequence represents a picture, or at least one picture, and the picture comprises a number of partitions, which are independent from each other with respect to decoding of the picture. The number of processing cores is less than the number of partitions, and the number of processing cores is greater than one.

As mentioned, the partitions may be slices or the partitions may be tiles.

According to some embodiments herein, the encoder 120 may comprise a processing module 1510. In further embodiments, the processing module 1510 may comprise one or more of an estimating module 1520, an encoding module 1530 and a sorting module 1540, which may be configured as described below.

The multiple processing cores may be exemplified by a first processing core 1550, a second processing core 1560, a third processing core 1570 and/or further processing cores.

The encoder 120, the processing module 1510 and/or the estimating module 1520 is configured to estimate a set of values, wherein each value of the set corresponds to a corresponding partition of the number of partitions, wherein each value relates to encoding time of its corresponding partition.

The encoder 120, the processing module 1510 and/or the encoding module 1530 is configured to encode the number of partitions based on the encoding time as given by the set of values. The encoder 120, the processing module 1510 and/or the encoding module 1530 is configured to encode the number of partitions by use of the number of processing cores, at least initially, in parallel.

The encoder 120, the processing module 1510 and/or the encoding module 1530 may be configured to encode the number of partitions based on the encoding time as given by the set of values by being configured to encode the number of partitions in descending order with respect to the encoding time as given by the set of values.

The encoder 120, the processing module 1510 and/or the estimating module 1520 may be configured to estimate the set of values based on a respective size of the respective partition.

The respective size of the respective partition may relate to a respective size of the encoded respective partition in pixels, or wherein the respective size of the respective partition may relate to a respective size of a portion of a bitstream, including the respective partition, in bits.

The encoder 120, the processing module 1510 and/or the estimating module 1520 may be configured to estimate the set of values based on a further respective size of a further respective partition relating to a previous picture in relation to the picture. The previous picture may be comprised in the video sequence.

The video sequence may comprise a previous picture, being previous in encoding order to the picture. The encoder 120, the processing module 1510 and/or the estimating module 1520 may be configured to estimate the set of values by being configured to measure, for each partition, a difference in pixel between the previous picture and the picture.

The video sequence may comprise a previous picture, being previous in encoding order to the picture. The encoder 120, the processing module 1510 and/or the estimating module 1520 may be configured to estimate the set of values based on a respective encoding time of a respective previous partition in the previous picture.

The encoder 120, the processing module 1510 and/or the sorting module 1540 may be configured to sort the number of partitions into a sorted list. The list may be sorted in descending order with respect to the encoding time as given by the set of values.

The number of processing cores may be N.

The encoder 120, the processing module 1510 and/or the encoding module 1530 may be configured to encode, in each of the number of processing cores, a respective one of the first N partitions of the sorted list.

The encoder 120, the processing module 1510 and/or the encoding module 1530 may be configured to encode, in said any one of the N processing cores, any partition that may be the first non-encoded partition according to the sorted list, when any one of the N processing cores has finalized the encoding of the respective one of the first N partitions.

FIG. 15 also illustrates software in the form of a computer program 1501 for managing a video sequence. The computer program 1501 comprises computer readable code units which when executed on the encoder 120 causes the encoder 120 to perform the method in the decoder 120 as disclosed herein.

Finally, FIG. 15 illustrates a computer program product 1502, comprising computer readable medium 1503 and the computer program 1501 as described directly above stored on the computer readable medium 1503.

The encoder 120 may further comprise an Input/output (I/O) unit 1504 configured to send and/or receive the bitstream and other messages, values, indications and the like as described herein. The I/O unit 1504 may comprise a receiving module (not shown), a sending module (not shown), a transmitter and/or a receiver.

Furthermore, the encoder 120 may comprise a memory 1505 for storing software to be executed by, for example, the processing module when the processing module is implemented as a hardware module comprising at least two processing cores or the like.

As used herein, the term “processing module” may refer to a processing circuit, a processing unit, a processor, an Application Specific integrated Circuit (ASIC), a Field-Programmable Gate Array (FPGA) or the like. As an example, a processor, an ASIC, an FPGA or the like may comprise one or more processor kernels. In some examples, the processing module may be embodied by a software module or hardware module. Any such module may be a determining means, estimating means, capturing means, associating means, comparing means, identification means, selecting means, receiving means, transmitting means or the like as disclosed herein. As an example, the expression “means” may be a module, such as a determining module, selecting module, etc.

As used herein, the expression “configured to” may mean that a processing circuit is configured to, or adapted to, by means of software configuration and/or hardware configuration, perform one or more of the actions described herein.

As used herein, the term “memory” may refer to a hard disk, a magnetic storage medium, a portable computer diskette or disc, flash memory, random access memory (RAM) or the like. Furthermore, the term “memory” may refer to an internal register memory of a processor or the like.

As used herein, the term “computer readable medium” may be a Universal Serial Bus (USB) memory, a DVD-disc, a Blu-ray disc, a software module that is received as a stream of data, a Flash memory, a hard drive, a memory card, such as a MemoryStick, a Multimedia Card (MMC), etc.

As used herein, the terms “number”, “value” may be any kind of digit, such as binary, real, imaginary or rational number or the like. Moreover, “number”, “value” may be one or more characters, such as a letter or a string of letters. “number”, “value” may also be represented by a bit string.

As used herein, the expression “in some embodiments” has been used to indicate that the features of the embodiment described may be combined with any other embodiment disclosed herein.

Even though embodiments of the various aspects have been described, many different alterations, modifications and the like thereof will become apparent for those skilled in the art. The described embodiments are therefore not intended to limit the scope of the present disclosure.

1. A method, performed by a decoder comprising multiple processing cores enabling parallel decoding, for managing a coded video sequence while using at least a number of processing cores of the decoder, wherein the coded video sequence represents a picture, wherein the picture comprises a number of partitions, which are independent from each other with respect to decoding of the picture, wherein the method comprises:
estimating a set of values, wherein each value of the set corresponds to a corresponding partition of the number of partitions, wherein each value relates to decoding time of its corresponding partition; and
decoding the number of partitions based on the decoding time as given by the set of values, wherein the decoding is performed by using the number of processing cores, at least initially, in parallel,
wherein the number of processing cores is less than the number of partitions, and the number of processing cores is greater than one.

2.-8. (canceled)

9. A method, performed by an encoder comprising multiple processing cores enabling parallel encoding, for managing a video sequence while using at least a number of processing cores of the encoder, wherein the video sequence represents a picture and the picture comprises a number of partitions, which are independent from each other with respect to encoding of the picture, wherein the method comprises:
estimating a set of values, wherein each value of the set corresponds to a corresponding partition of the number of partitions, wherein each value relates to encoding time of its corresponding partition; and
encoding the number of partitions based on the encoding time as given by the set of values, wherein the encoding is performed by using the number of processing cores, at least initially, in parallel,
wherein the number of processing cores is less than the number of partitions, and the number of processing cores is greater than one.

10.-18. (canceled)

19. A decoder comprising multiple processing cores enabling parallel decoding, configured to manage a coded video sequence while using at least a number of processing cores of the decoder, wherein the coded video sequence represents a picture, wherein the picture comprises a number of partitions, which are independent from each other with respect to decoding of the picture, wherein the decoder is configured to:
estimate a set of values, wherein each value of the set corresponds to a corresponding partition of the number of partitions, wherein each value relates to decoding time of its corresponding partition; and
decode the number of partitions based on the decoding time as given by the set of values, wherein the decoder is configured to decode the number of partitions by use of the number of processing cores, at least initially, in parallel,
wherein the number of processing cores is less than the number of partitions, and the number of processing cores is greater than one.

20. The decoder according to claim 19, wherein the decoder is configured to decode the number of partitions based on the decoding time as given by the set of values by being configured to decode the number of partitions in descending order with respect to the decoding time as given by the set of values.

21. The decoder according to claim 19, wherein the decoder is configured to estimate the set of values based on a respective size of the respective partition.

22.-26. (canceled)

27. An encoder, comprising multiple processing cores enabling parallel encoding, configured to manage a video sequence while using at least a number of processing cores of the encoder, wherein the video sequence represents a picture and the picture comprises a number of partitions, which are independent from each other with respect to encoding of the picture, wherein the encoder is configured to:
estimate a set of values, wherein each value of the set corresponds to a corresponding partition of the number of partitions, wherein each value relates to encoding time of its corresponding partition; and
encode the number of partitions based on the encoding time as given by the set of values, wherein the encoder is configured to encode the number of partitions by use of the number of processing cores, at least initially, in parallel,
wherein the number of processing cores is less than the number of partitions, and the number of processing cores is greater than one.

28. The encoder according to claim 27, wherein the encoder is configured to encode the number of partitions based on the encoding time as given by the set of values by being configured to encode the number of partitions in descending order with respect to the encoding time as given by the set of values.

29. The encoder according to claim 27, wherein the encoder is configured to estimate the set of values based on a respective size of the respective partition.

30. The encoder according to claim 29, wherein the respective size of the respective partition relates to a respective size of the encoded respective partition in pixels, or wherein the respective size of the respective partition relates to a respective size of a portion of a bitstream, including the respective partition, in bits.

31. The encoder according to claim 27, wherein the encoder is configured to estimate the set of values based on a further respective size of a further respective partition relating to a previous picture in relation to the picture, wherein the previous picture is comprised in the video sequence.

32.-36. (canceled)

37. A computer program product comprising a non-transitory computer readable storage medium storing instructions for managing a coded video sequence, wherein the computer program comprises computer readable code which when executed on a processor of a decoder causes the decoder to perform the method according to claim 1.

38. (canceled)

39. A computer program product comprising a non-transitory computer readable storage medium storing instructions for managing a video sequence, wherein the computer program comprises computer readable code which when executed on a processor of an encoder causes the encoder to perform the method according to claim 9.

40. (canceled)
